(19) United States
(12) Patent Application Publication
(10) Pub. No.: US 2015/0115765 A1
(43) Pub. Date: Apr. 30, 2015

(54) MOTOR AND METHOD OF WINDING STATOR COIL

(71) Applicant: SAMSUNG ELECTRONICS CO., LTD., Suwon-si (KR)

(72) Inventors: Byoung Soo KO, Seoul (KR); Dong Woo Kang, Seoul (KR); Kang Rib Kim, Suwon-si (KR); Young Kwan Kim, Anyang-si (KR); Hong Seok Kim, Yongin-si (KR)

(73) Assignee: SAMSUNG ELECTRONICS CO., LTD., Suwon-si (KR)

(21) Appl. No.: 14/305,380

(22) Filed: Jun. 16, 2014

(30) Foreign Application Priority Data
Oct. 29, 2013 (KR) 10-2013-0129010

(51) Int. Cl. H02K 3/34

(52) U.S. Cl. CPC H02K 3/345
USPC 310/215

(57) ABSTRACT

A motor having an improved structure in which winding patterns of a stator coil can be simplified, and a method of winding a stator coil. The motor includes a stator, a rotor and a motor shaft. The stator has a stator body and a first insulator and a second insulator that are coupled to upper and lower parts of the stator body. The rotor is disposed in the stator and configured to rotate while electromagnetically interacting with the stator. The motor shaft is coupled to the rotor so as to rotate together with the rotor, and a plurality of binding bosses are provided along a circumferential direction of one of the first insulator and the second insulator so that coils to which different voltages are applied, are wound around one of the first insulator and the second insulator.

### CROSS-REFERENCE TO RELATED APPLICATIONS

This application claims the benefit of Korean Patent Application No. P2013-129010, filed on Oct. 29, 2013 in the Korean Intellectual Property Office, the disclosure of which is incorporated herein by reference.

### BACKGROUND

1. Field

Embodiments of the present disclosure relate to a motor and a method of winding a stator coil, and more particularly, to a motor having an improved structure in which winding patterns of a stator coil can be simplified, and a method of winding a stator coil.

2. Description of the Related Art

Motors are machines that obtain a rotational force from electric energy. A motor includes a stator and a rotor. The rotor is configured to electromagnetically interact with the stator and rotates due to force applied between a magnetic field and a current that flows through coils.

A brushless DC (BLDC) motor is a motor in which a brush and a rectifier disposed at a DC motor are omitted and an electromagnetic rectifying instrument is installed. The BLDC motor causes no mechanical noise and no electrical noise.

In general, a stator of the BLDC motor uses a magmate so as to connect a common line of phases each having an electric potential difference.

Since the magmate mounted on an insulator of the stator has a predetermined size, it is difficult in a small-sized motor to obtain a space in which the magmate is mounted.

Also, since the small-sized motor uses coils each having a relatively small diameter, when sheaths of coils having different phases are peeled off, the coils may be disconnected.

### SUMMARY

Therefore, it is an aspect of the present disclosure to provide a motor having an improved structure in which a magmate can be omitted, and a method of winding a stator coil.

It is another aspect of the present disclosure to provide a motor having an improved structure in which coils can be prevented from being cut when sheaths of the coils are peeled off and winding patterns can be simplified, and a method of winding a stator coil.

Additional aspects of the disclosure will be set forth in part in the description which follows and, in part, will be obvious from the description, or may be learned by practice of the disclosure.

In accordance with one aspect of the present disclosure, a motor includes: a stator including a stator body and a first insulator and a second insulator that are coupled to upper and lower parts of the stator body; a rotor disposed in the stator and configured to rotate while electromagnetically interacting with the stator; and a motor shaft coupled to the rotor so as to rotate together with the rotor, wherein a plurality of binding bosses are provided along a circumferential direction of one of the first insulator and the second insulator so that coils to which different voltages are applied, are wound around one of the first insulator and the second insulator.

The plurality of binding bosses may include: a first binding boss around which a first coil to which a first voltage is applied, is wound; and a second binding boss around which a second coil to which a second voltage is applied, is wound, and the second coil may extend from the first coil and may be integrated with the first coil.

The first coil may be inserted into the first binding boss, may be wound around a drawing boss spaced apart from the first binding boss, and then may be wound around the second binding boss.

The second binding boss may be placed between the first binding boss and the drawing boss.

The plurality of binding bosses may further include a third binding boss around which a third coil to which a third voltage is applied, is wound, and the third coil may be inserted into the third binding boss.

The third binding boss may be placed between the second binding boss and the drawing boss, and the third coil may be wound around the drawing boss.

The first coil and the third coil may be connected to each other in the drawing boss and may constitute a common portion.

Each of the first insulator and the second insulator may include: a ring-shaped frame; coil support parts that are disposed to correspond to the plurality of stator cores disposed along a circumferential direction of the stator body and extend from the frame toward a radial inner side of the frame; and coil guide parts that are disposed on one end of each of the coil support parts to face an outer circumferential surface of the rotor and protrude in a direction in which the coil guide parts are far away from the stator body, and the plurality of binding bosses may be provided on the frame of one of the first insulator and the second insulator so as to face the coil guide parts.

The plurality of binding bosses may include first ribs and second ribs spaced apart from the first ribs, and the first ribs and the second ribs may include: a body that extends from the frame; and a hanging jaw formed on one end of the body so as to protrude toward an outer side of the body.

Terminal coupling holes may be formed between the first ribs and the second ribs so that terminals are capable of being coupled into the terminal coupling holes.

The terminals may be coupled in the terminal coupling holes and may be connected to the first coil and the third coil in at least one of the first binding boss, the drawing boss, the second binding boss, and the third binding boss.

Sheaths of the first coil, the third coil, and the terminals may be peeled off by a rotatable blade of a stripping device so that at least one of the first coil and the third coil is capable of being connected to the terminals.

The stripping device may include an end mill.

In accordance with another aspect of the present disclosure, a motor includes: a stator; and a rotor configured to rotate while electromagnetically interacting with the stator, wherein the stator may include: a stator body in which a plurality of stator cores are formed along a circumferential direction of the stator body; an insulator including a plurality of coil support parts arranged to correspond to the plurality of stator cores and coupled to upper and lower parts of the stator body so as to cover the stator cores; and a plurality of binding bosses that extend from the plurality of coil support parts and protrude, and the number of binding bosses around which a main coil is wound, may be greater than the number of binding bosses around which a subcoil to which a different voltage from a voltage applied to the main coil is applied, is wound.

The plurality of stator cores may include first through ninth stator cores sequentially arranged along the circumferential direction of the stator body, and the main coil may be inserted into the first stator core, may be wound by sequentially passing the fourth stator core and the seventh stator core, may be inserted into the sixth stator core, may be wound by passing the third stator core and the ninth stator core, and then may be drawn out of the ninth stator core, and the subcoil may be inserted into the eighth stator core, may be wound by sequentially passing the second stator core and the fifth stator core, and then may be drawn out of the fifth stator core, and a first voltage may be applied to the main coil inserted into the first stator core, and a second voltage may be applied to the main coil drawn out of the ninth stator core, and a third voltage may be applied to the subcoil inserted into the eighth stator core.

The plurality of binding bosses may include: a first binding boss around which the main coil inserted into the first stator core is wound; a second binding boss around which the main coil drawn out of the ninth stator core is wound; a third binding boss around which the subcoil inserted into the eighth stator core is wound; and a fourth binding boss around which the main coil drawn out of the seventh stator core and the subcoil drawn out of the fifth stator core are wound.

The first through fourth binding bosses may be spaced apart from each other and may be sequentially placed.

A common portion in which the main coil to which the first voltage and the second voltage are applied and the subcoil to which the third voltage is applied, are connected to each other, may be formed in the fourth binding boss.

In accordance with still another aspect of the present disclosure, a method of winding a stator coil around a stator including first through ninth stator cores sequentially arranged along a circumferential direction, includes: winding a main coil around a first binding boss; winding the main coil by sequentially passing the first stator core, the fourth stator core, and the seventh stator core; binding the main coil drawn out of the seventh stator core around a fourth binding boss and winding the main coil by sequentially passing the sixth stator core, the third stator core, and the ninth stator core; winding the main coil drawn out of the ninth stator core around a second binding boss; winding a subcoil around a third binding boss; winding the subcoil by sequentially passing the eighth stator core, the second stator core, and the fifth stator core and then cutting the subcoil; and winding the subcoil drawn out of the fifth stator core around the fourth binding boss so as to be connected to the main coil.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a cross-sectional view illustrating a configuration of a motor in accordance with an embodiment of the present disclosure;

FIG. 2 is an exploded perspective of a stator of the motor illustrated in FIG. 1;

FIG. 3 is an enlarged perspective view of a second insulator that constitutes the stator of

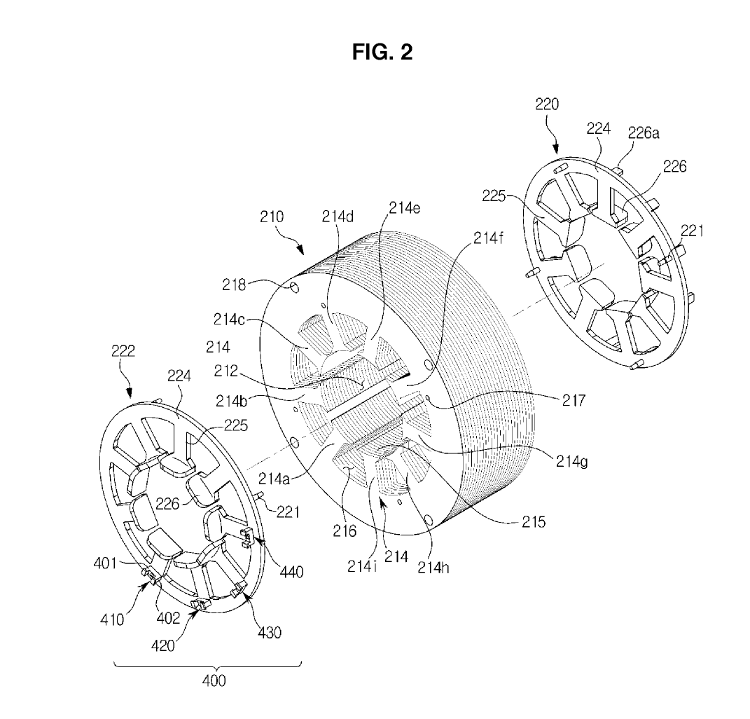

FIG. 2;

FIG. 4 is a block diagram illustrating a method of winding a stator coil, in accordance with an embodiment of the present disclosure;

FIG. 5 is a block diagram illustrating an operation of winding a main coil of the method of winding the stator coil of FIG. 4;

FIG. 6 is a block diagram illustrating an operation of winding a subcoil of the method of winding the stator coil of FIG. 4;

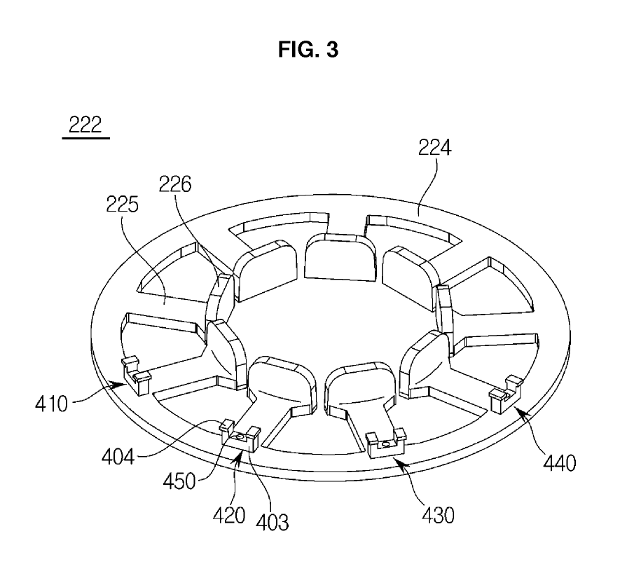

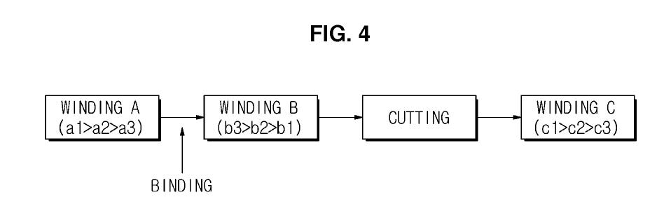

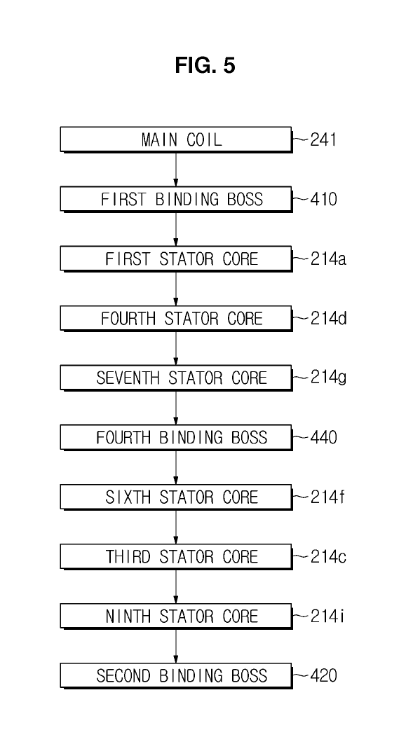

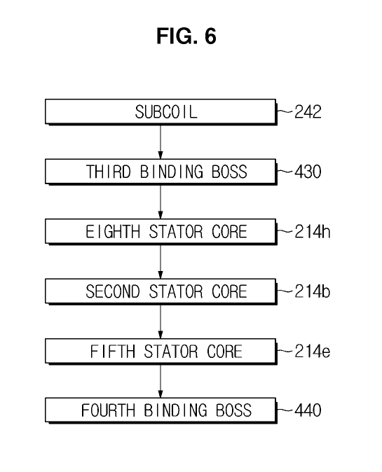

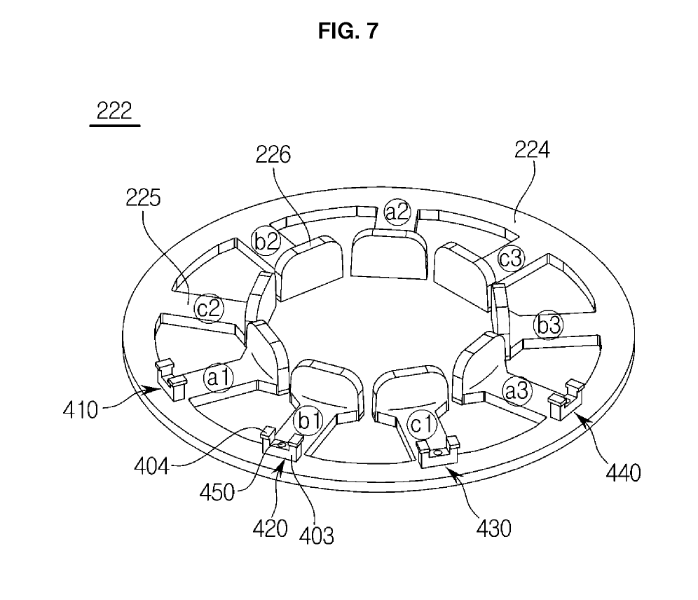

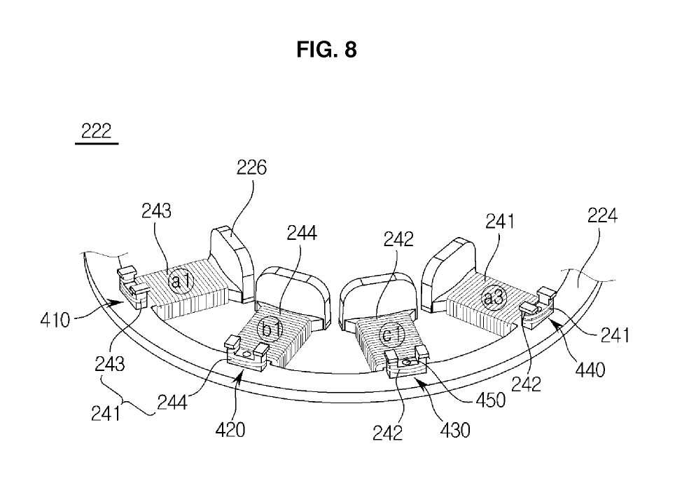

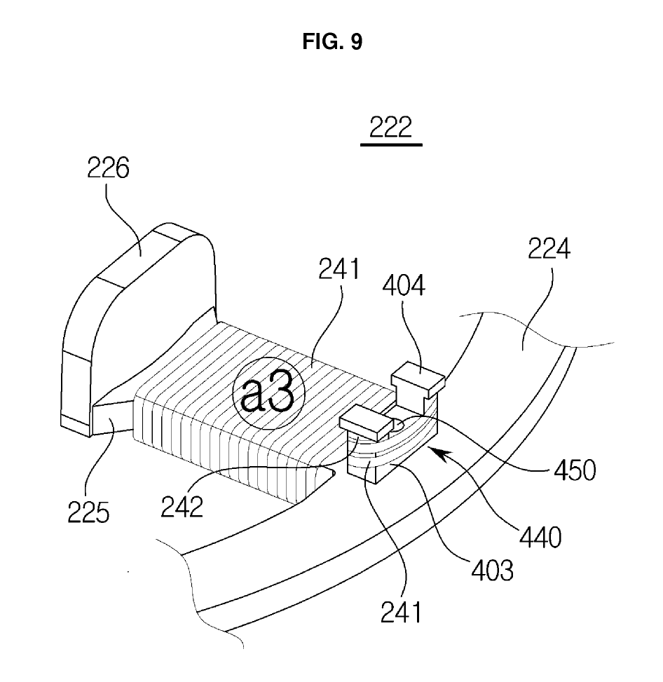

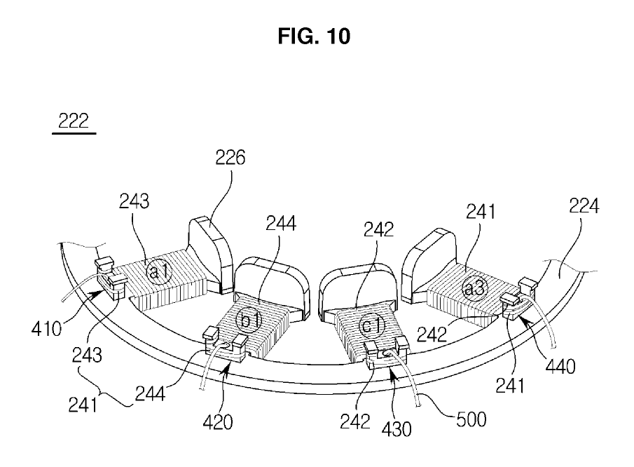

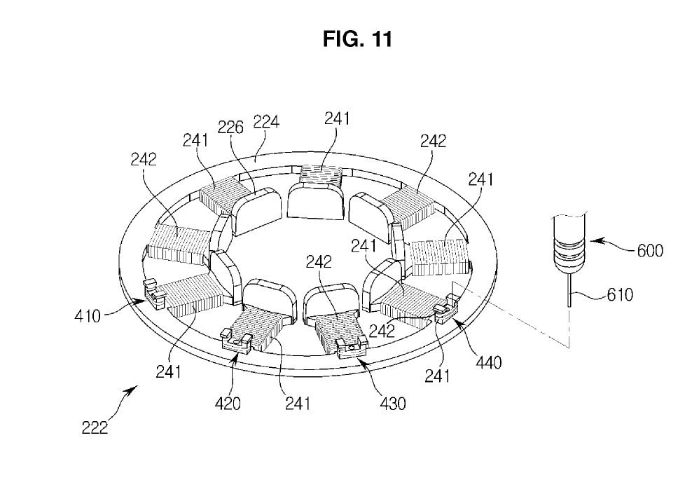

FIG. 7 illustrates a position in which the stator coil of each phase is wound around the second insulator illustrated in FIG. 3;

FIG. 8 is a partially enlarged perspective view of a state in which the stator coil is wound around the second insulator of FIG. 7;

FIG. 9 is an enlarged perspective view of a common portion of FIG. 8;

FIG. 10 is a perspective view illustrating a state in which terminals are coupled to the second insulator of FIG. 8; and

FIG. 11 is a perspective view illustrating a state in which the stator coil wound using the method of winding the stator coil of FIG. 4 and sheaths of the terminals are peeled off using a stripping device.

### DETAILED DESCRIPTION

Reference will now be made in detail to the embodiments of the present disclosure, examples of which are illustrated in the accompanying drawings, wherein like reference numerals refer to like elements throughout.

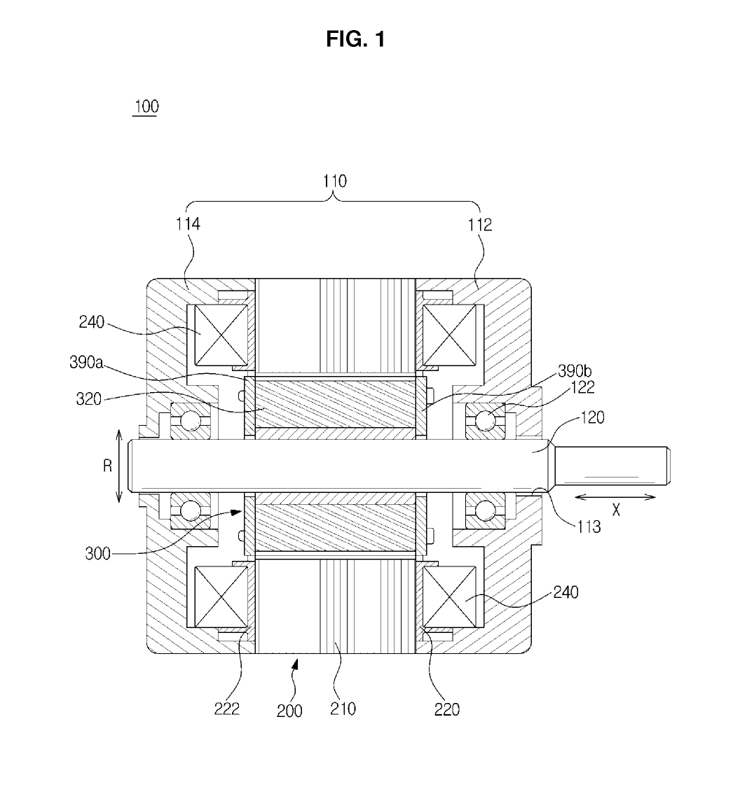

FIG. 1 is a cross-sectional view illustrating a configuration of a motor in accordance with an embodiment of the present disclosure, and FIG. 2 is an exploded perspective of a stator of the motor illustrated in FIG. 1. Also, FIG. 3 is an enlarged perspective view of a second insulator that constitutes the stator of FIG. 2. An axial direction X is a direction parallel to a motor axis. A radius direction R is a direction of a radius of a circle centering around the motor axis. For convenience of explanation, it is assumed that three-phase voltages A, B, and C are applied to a stator coil 240. Also, it is assumed that a stator 200 includes nine stator cores 214.

As illustrated in FIGS. 1 through 3, a motor 100 includes a motor housing 110 that constitutes an exterior of the motor 100. The motor housing 110 may include a first housing 112 and a second housing 114 that are separated from each other in an axial direction of the motor 100. The first housing 112 and the second housing 114 may be fastened to the stator 200.

The stator 200 and a rotor 300 are disposed in the motor housing 110. The stator 200 may be fixed to the motor housing 110. The rotor 300 is configured to rotate while electromagnetically interacting with the stator 200. The rotor 300 may be disposed in the stator 200.

A motor shaft 120 is inserted into the rotor 300 so as to rotate with the rotor 300. One side of the motor shaft 120 is rotatably supported on the first housing 112 via a bearing 122, and the other side of the motor shaft 120 is rotatably supported on the second housing 114 via the bearing 122. An end of one side of the motor shaft 120 protrudes toward an outer side of the motor housing 110 through an opening 113 formed in the first housing 112.

The stator 200 may include a stator body 210, a first insulator 220, a second insulator 222, and coils (not shown in FIGS. 1 and 2).

A space in which the rotor 300 is accommodated, is formed in the center of the stator body 210. The stator cores 214 are arranged around a rotor accommodation portion 212 along a circumferential direction (C-direction, see FIG. 5) of the rotor 300. The stator cores 214 extend from the rotor accommodation portion 212 in a radial direction. The stator body 210 may be formed by stacking iron plates manufactured by press working.

The stator cores 214 are arranged in a circumferential direction of the stator body 210 at predetermined intervals, and stator slots 216 are formed between the stator cores 214. As the stator coil 240 is wound around the stator cores 214, the stator coil 240 is accommodated in the stator slots 216. An enlarged core portion 215 in which widths of the stator cores 214 are partially enlarged, is formed at inner ends of the stator cores 214 that are adjacent to the rotor 300. Pores through which rotation of the rotor 300 is performed, are formed between an inner surface of the enlarged core portion 215 and an outer surface of the rotor 300.

The first insulator 220 and the second insulator 222 are formed of materials having electric insulation and are disposed at both sides of the stator body 210 with respect to the axial direction. The first insulator 220 and the second insulator 222 are coupled to both sides of the stator body 210 so as to cover the stator cores 214. In detail, the first insulator 220 is coupled to a lower side of the stator body 210 so as to cover lower sides of the stator cores 214, and the second insulator 222 is coupled to an upper side of the stator body 210 so as to cover upper sides of the stator cores 214.

Coupling protrusions 221 that protrude toward the stator body 210 are formed on the first insulator 220 and the second insulator 222. The coupling protrusions 221 are inserted into coupling holes 217 formed in the stator body 210.

The first insulator 220 and the second insulator 222 are disposed to correspond to a ring-shaped frame 224 and the stator cores 214. Each of the first insulator 220 and the second insulator 222 includes coil support parts 225 that extend from the frame 224 to a radial inner side of the frame 224, first coil guide parts 226 that protrude from radial inner sides of the coil support parts 225, and second coil guide parts 226a that protrude from radial outer sides of the coil support parts 225. The first coil guide parts 226 may be disposed on one end of each of the coil support parts 225 so as to face an outer circumferential surface of the rotor 300 and may protrude in a direction in which the first coil guide parts 226 are far away from the stator body 210. In the present disclosure, a coil guide parts 226 may be used in the same meaning as that of the first coil guide parts 226.

The coil support parts 225 are spaced apart from each other in the circumferential direction, and a space corresponding to the stator cores 214 is formed between the coil support parts 225.

The stator coil 240 is wound around the stator cores 214 and the coil support parts 225 of the first and second insulators 220 and 222 in a state in which the first insulator 220 and the second insulator 222 are coupled to the stator body 210.

Insertion holes 218 that perforate the stator body 210 in the axial direction, may be formed in the stator body 210. A fastening member (not shown) that fastens plates of the stator body 210 to each other, such as a pin, a rivet, or a bolt, is inserted into the insertion holes 218.

Housing perforation holes (not shown) corresponding to the insertion holes 218 of the stator body 210 may be formed in the first housing 112 and the second housing 114 so that the first housing 112, the second housing 114, and the stator 200 can be fixed using one fastening member.

The rotor 300 includes a rotor body (not shown) disposed on the rotor accommodation portion 212 of the stator body 210 and permanent magnets 320 inserted into an inner side of the rotor body (not shown). The rotor body (not shown) may be formed by stacking plates manufactured by press working a silicon steel plate.

A first cover plate 390a and a second cover plate 390b may be disposed at both sides of the rotor body (not shown) in the axial direction (X-direction) so as to reinforce structural rigidity of the rotor 300. Axial accommodation holes (not shown) in which the motor shaft 120 can be accommodated, are formed in the center of the first cover plate 390a and the second cover plate 390b.

The first and second cover plates 390a and 390b are disposed to cover an outer side of the permanent magnet 320 in the axial direction and prevent the permanent magnet 320 from being deviated from the rotor 300 in the axial direction. Also, the first and second cover plates 390a and 390b may be used as structures for balancing when unbalance exists in the rotor 300. The first and second cover plates 390a and 390b may be disposed using nonmagnetic substances, for example, copper and stainless steel.

The permanent magnets 320 may be arranged along the circumferential direction of the rotor 300 so as to be placed in the radial direction around the motor shaft 120. The permanent magnets 320 may be ferrite magnets or magnets including rare earth resources, such as neodymium or samarium.

A plurality of binding bosses 400 may be disposed on one of the first insulator 220 and the second insulator 222. The plurality of binding bosses 400 may be disposed along a circumferential direction of one of the first insulator 220 and the second insulator 222 so that the stator coil 240 to which different voltages are applied, can be wound around the stator cores 214.

When the plurality of binding bosses 400 is disposed on one of the first insulator 220 and the second insulator 222, the second coil guide parts 226a may be disposed on the other one of the first insulator 220 and the second insulator 222. That is, if the plurality of binding bosses 400 are disposed on the first insulator 220, the second coil guide parts 226a may be disposed on the second insulator 222, and if the plurality of binding bosses 400 are disposed on the second insulator 222, the second coil guide parts 226a may be disposed on the first insulator 220.

Each of the plurality of binding bosses 400 may include first ribs 401, second ribs 402 that are spaced apart from the first ribs 401, and terminal coupling holes 450.

Each of the first ribs 401 and the second ribs 402 may include a body 403 disposed on the frame 224 so as to protrude toward radial outer sides of the coil support parts 225 and a hanging jaw 404 formed on one end of the body 403 toward the radial outer sides of the coil support parts 225 so that the hanging jaw 404 can protrude toward an outer side of the body 403.

The terminal coupling holes 450 may be formed between the first ribs 401 and the second ribs 402 and may have a shape in which the terminal coupling holes 450 are depressed toward the stator body 210 so that terminals 500 (see FIG. 10) can be coupled into the terminal coupling holes 450.

A procedure in which the terminals 500 coupled into the terminal coupling holes 450 and the stator coil 240 to which different voltages are applied, are connected to each other, will be described later.

The plurality of binding bosses 400 may include a first binding boss 410, a second binding boss 420, a third binding boss 430, and a fourth binding boss 440. As a non-limiting example, the fourth binding boss 440 may be used in the same meaning as that of a drawing boss. The drawing boss is a binding boss where at least two coils are connected.

A first coil 243 to which a first voltage is applied, is wound around the first binding boss 410, and a second coil 244 to which a second voltage is applied, is wound around the second binding boss 420 (see e.g. FIG. 8). Also, a third coil 242 to which a third voltage is applied, may be wound around the third binding boss 430 (see e.g. FIG. 8).

The stator coil 240 may be inserted into the first binding boss 410, may be wound around the fourth binding boss 440 spaced apart from the first binding boss 410, and then may be wound around the second binding boss 420.

The first binding boss 410, the second binding boss 420, the third binding boss 430, and the fourth binding boss 440 may be sequentially disposed on the frame 224 of one of the first insulator 220 and the second insulator 222 counterclockwise. Also, the first binding boss 410, the second binding boss 420, the third binding boss 430, and the fourth binding boss 440 may be disposed to be spaced apart from each other.

The second coil 244 may extend from the first coil 243 and may be integrated with the first coil 243. Thus, the first coil 243 and the second coil 244 constitute one coil, and for convenience of explanation, the first coil 243 and the second coil 244 are referred to as a main coil 241. Also, the third coil 242 that is separate from the main coil 241 is referred to as a subcoil 242 for convenience of explanation. The stator coil 240 refers to both the main coil 241 and the subcoil 242.

FIG. 4 is a block diagram illustrating a method of winding a stator coil, in accordance with an embodiment of the present disclosure, and FIG. 5 is a block diagram illustrating an operation of winding a main coil of the method of winding the stator coil of FIG. 4. FIG. 6 is a block diagram illustrating an operation of winding a subcoil of the method of winding the stator coil of FIG. 4, and FIG. 7 illustrates a position in which the stator coil of each phase is wound around the second insulator illustrated in FIG. 3. FIG. 8 is a partially enlarged perspective view of a state in which the stator coil is wound around the second insulator of FIG. 7, and FIG. 9 is an enlarged perspective view of a common portion of FIG. 8. The fourth binding boss 440 may be used in the same meaning as that of the drawing boss. The coil support parts 225 around which the main coil 241 to which a first voltage is applied is wound, are marked as A(a1, a2, a3), and the coil support parts 225 around which the main coil 241 to which a second voltage is applied is wound, are marked as B(b1, b2, b3). Also, the coil support parts 225 around which the subcoil 242 to which a third voltage is applied is wound, are marked as C(c1, c2, c3). The main coil 241 to which the first voltage is applied, is wound in the order of a1, a2, and a3, and the main coil 241 to which the second voltage is applied, is wound in the order of b3, b2, and b1, and the subcoil 242 to which the third voltage is applied, is wound in the order of c1, c2, and c3.

As illustrated in FIGS. 4 through 9, the main coil 241 and the subcoil 242 may be wound around the coil support parts 225, the stator cores 214 corresponding to the coil support parts 225, and the plurality of binding bosses 400. The stator 200 may include a first stator core 214a through a ninth stator core 214i that are sequentially arranged along the circumferential direction.

The number of binding bosses 400 around which the main coil 241 is wound, is greater than the number of binding bosses 400 around which the subcoil 242 is wound.

In detail, the main coil 241 is wound around the first binding boss 410, is inserted into the first stator core 214a, is wound by sequentially passing a fourth stator core 214d and a seventh stator core 214g, is inserted into a sixth stator core 214f, is wound by passing a third stator core 214c and a ninth stator core 214i, is drawn out of the ninth stator core 214i, and then is wound around the second binding boss 420. The subcoil 242 is wound around a third binding boss 430, is inserted into an eighth stator core 214h, is wound by sequentially passing a second stator core 214b and a fifth stator core 214e, and then is drawn out of the fifth stator core 214e. The subcoil 242 drawn out of the fifth stator core 214e is wound around the fourth binding boss 440. Thus, the main coil 241 is wound around three binding bosses including the first binding boss 410, the second binding boss 420, and the fourth binding boss 440, and the subcoil 242 is wound around two binding bosses including the third binding boss 430 and the fourth binding boss 440.

A method of winding the stator coil 240 will be described as below (see e.g. FIGS. 5 and 6).

Turning to FIG. 5, the main coil 241 is wound around the first binding boss 410, is wound by sequentially passing the first stator core 214a, the fourth stator core 214d, and the seventh stator core 214g. Then, the main coil 241 drawn out of the seventh stator core 214g is bound in the fourth binding boss 440 and then is wound by sequentially passing the sixth stator core 214f, the third stator core 214c, and the ninth stator core 214i. Then, the main coil 241 drawn out of the ninth stator core 214i is wound around the second binding boss 420. In FIG. 6, the subcoil 242 is wound around the third binding boss 430 and is wound by sequentially passing the eighth stator core 214h, the second stator core 214b, and the fifth stator core 214e and then is cut, and the subcoil 242 drawn out of the fifth stator core 214e is wound around the fourth binding boss 440 so as to be connected to the main coil 241.

The main coil 241 and the subcoil 242 may be wound around in at least one of the first ribs 401 and the second ribs 402.

The main coil 241 and the subcoil 242 may be connected to each other in the fourth binding boss 440, thereby constituting a common portion (not shown). A first voltage is applied to the main coil 241 wound around the first binding boss 410 so as to be inserted into the first stator core 214a, and a second voltage is applied to the main coil 241 wound around the second binding boss 420 so as to be drawn out of the ninth stator core 214i. Also, a third voltage is applied to the subcoil 242 having one end wound around the third binding boss 430 and the other end drawn out of the fifth stator core 214e and wound around the fourth binding boss 440. Thus, the first voltage, the second voltage, and the third voltage are combined with each other in the common portion (not shown) in which the main coil 241 and the subcoil 242 are connected to each other.

Thus, in order to constitute the common portion (not shown), instead of cutting a coil to which the first voltage is applied, a coil to which the second voltage is applied, and a coil to which the third voltage is applied and then connecting cut ends of the coils, the main coil to which the first voltage and the second voltage are applied and the subcoil to which the third voltage is applied, are respectively cut and then cut ends of the main coil and the subcoil are connected to each other. Thus, the number of winding operations can be reduced.

A method of connecting the main coil 241 and the subcoil 242 will now be described.

FIG. 10 is a perspective view illustrating a state in which terminals are coupled to the second insulator of FIG. 8.

Description of reference numerals A(a1,a2,a3), B(b1,b2,b3), and C(c1,c2,c3) will be provided with reference to FIGS. 4 through 7 described above.

As illustrated in FIG. 10, the terminals 500 may be connected into the terminal coupling holes 450 formed between the first ribs 401 and the second ribs 402. In detail, the terminals 500 coupled into the terminal coupling holes 450 may be connected to the main coil 241 and the subcoil 242 in at least one of the first binding boss 410, the second binding boss 420, the third binding boss 430, and the fourth binding boss 440. The terminals 500 coupled into the terminal coupling holes 450 of the fourth binding boss 440 that constitutes the common portion (not shown) may be connected to both the main coil 241 and the subcoil 242.

FIG. 11 is a perspective view illustrating a state in which the stator coil wound using the method of winding the stator coil of FIG. 4 and sheaths of the terminals are peeled off using a stripping device.

As illustrated in FIG. 11, sheaths of the stator coil 240 and the terminal 500 may be peeled off using a stripping device 600. In detail, in order to connect the main coil 241 and the subcoil 242 or to connect at least one of the main coil 241 and the subcoil 242 and the terminals 500, sheaths of the main coil 241, the subcoil 242, and the terminals 500 are required to be peeled off. The sheaths of the main coil 241, the subcoil 242, and the terminals 500 may be peeled off by a rotatable blade 610 of the stripping device 600.

If the sheaths of the main coil 241 and the subcoil 242 wound around the fourth binding boss 440 are peeled off and are soldered, electricity flows between the main coil 241 and the subcoil 242. Also, if the terminals 500, sheaths of which are peeled off, are inserted into the terminal coupling holes 450 and are soldered with at least one of the main coil 241 and the subcoil 242, sheaths of which are peeled off, electricity flows between the terminals 500 and at least of the main coil 241 and the subcoil 242.

The stripping device 600 may include an end mill.

As described above, in a motor and a method of winding a stator coil according to the one or more embodiments of the present disclosure, a structure (magmate) for coupling a plurality of coils to which different voltages are applied, is omitted so that a spatial limit that may occur when the structure is installed at an insulator of the motor can be solved.

Winding patterns of the stator coil are simplified so that the number of manufacturing processes of the motor can be reduced and manufacturing costs of the motor can be reduced.

When a plurality of coils to which different voltages are applied, are coupled to each other, a stripping device, such as an end mill, is used to prevent the plurality of coils from being cut.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A motor comprising:
a stator comprising a stator body and a first insulator and a second insulator that are coupled to upper and lower parts of the stator body;
a rotor disposed in the stator and configured to rotate while electromagnetically interacting with the stator; and
a motor shaft coupled to the rotor so as to rotate together with the rotor,
wherein a plurality of binding bosses are provided along a circumferential direction of one of the first insulator and the second insulator so that coils to which different voltages are applied, are wound around one of the first insulator and the second insulator.

2. The motor of claim 1, wherein the plurality of binding bosses comprise:
a first binding boss around which a first coil to which a first voltage is applied, is wound; and
a second binding boss around which a second coil to which a second voltage is applied, is wound, and
the second coil extends from the first coil and is integrated with the first coil.

3. The motor of claim 2, wherein the first coil is inserted into the first binding boss, is wound around a drawing boss spaced apart from the first binding boss, and then is wound around the second binding boss.

4. The motor of claim 3, wherein the second binding boss is placed between the first binding boss and the drawing boss.

5. The motor of claim 3, wherein the plurality of binding bosses further comprise a third binding boss around which a third coil to which a third voltage is applied, is wound, and
the third coil is inserted into the third binding boss.

6. The motor of claim 5, wherein the third binding boss is placed between the second binding boss and the drawing boss, and
the third coil is wound around the drawing boss.

7. The motor of claim 6, wherein the first coil and the third coil are connected to each other in the drawing boss and constitute a common portion.

8. The motor of claim 6, wherein each of the first insulator and the second insulator comprises:
a ring-shaped frame;
coil support parts that are disposed to correspond to the plurality of stator cores disposed along a circumferential direction of the stator body and extend from the frame toward a radial inner side of the frame; and
coil guide parts that are disposed on one end of each of the coil support parts to face an outer circumferential surface of the rotor and protrude in a direction in which the coil guide parts are far away from the stator body, and
the plurality of binding bosses are provided on the frame of one of the first insulator and the second insulator so as to face the coil guide parts.

9. The motor of claim 8, wherein the plurality of binding bosses comprise first ribs and second ribs spaced apart from the first ribs, and
the first ribs and the second ribs comprise:
a body that extends from the frame; and
a hanging jaw formed on one end of the body so as to protrude toward an outer side of the body.

10. The motor of claim 9, wherein terminal coupling holes are formed between the first ribs and the second ribs so that terminals are capable of being coupled into the terminal coupling holes.

11. The motor of claim 10, wherein the terminals are coupled in the terminal coupling holes and are connected to the first coil and the third coil in at least one of the first binding boss, the drawing boss, the second binding boss, and the third binding boss.

12. The motor of claim 11, wherein sheaths of the first coil, the third coil, and the terminals are peeled off by a rotatable blade of a stripping device so that at least one of the first coil and the third coil is capable of being connected to the terminals.

13. The motor of claim 12, wherein the stripping device comprises an end mill.

14. A motor comprising:
a stator; and
a rotor configured to rotate while electromagnetically interacting with the stator,
wherein the stator comprises:
a stator body in which a plurality of stator cores are formed along a circumferential direction of the stator body;
an insulator comprising a plurality of coil support parts arranged to correspond to the plurality of stator cores and coupled to upper and lower parts of the stator body so as to cover the stator cores; and
a plurality of binding bosses that extend from the plurality of coil support parts and protrude, and
the number of binding bosses around which a main coil is wound, is greater than the number of binding bosses around which a subcoil to which a different voltage from a voltage applied to the main coil is applied, is wound.

15. The motor of claim 14, wherein the plurality of stator cores comprise first through ninth stator cores sequentially arranged along the circumferential direction of the stator body, and
the main coil is inserted into the first stator core, is wound by sequentially passing the fourth stator core and the seventh stator core, is inserted into the sixth stator core, is wound by passing the third stator core and the ninth stator core, and then is drawn out of the ninth stator core, and
the subcoil is inserted into the eighth stator core, is wound by sequentially passing the second stator core and the fifth stator core, and then is drawn out of the fifth stator core, and
a first voltage is applied to the main coil inserted into the first stator core, and a second voltage is applied to the main coil drawn out of the ninth stator core, and a third voltage is applied to the subcoil inserted into the eighth stator core.

16. The motor of claim 15, wherein the plurality of binding bosses comprise:
a first binding boss around which the main coil inserted into the first stator core is wound;
a second binding boss around which the main coil drawn out of the ninth stator core is wound;
a third binding boss around which the subcoil inserted into the eighth stator core is wound; and
a fourth binding boss around which the main coil drawn out of the seventh stator core and the subcoil drawn out of the fifth stator core are wound.

17. The motor of claim 16, wherein the first through fourth binding bosses are spaced apart from each other and are sequentially placed.

18. The motor of claim 16, wherein a common portion in which the main coil to which the first voltage and the second voltage are applied and the subcoil to which the third voltage is applied, are connected to each other, is formed in the fourth binding boss.

19. A method of winding a stator coil around a stator comprising first through ninth stator cores sequentially arranged along a circumferential direction, the method comprising:
winding a main coil around a first binding boss;
winding the main coil by sequentially passing the first stator core, the fourth stator core, and the seventh stator core;
binding the main coil drawn out of the seventh stator core around a fourth binding boss and winding the main coil by sequentially passing the sixth stator core, the third stator core, and the ninth stator core;
winding the main coil drawn out of the ninth stator core around a second binding boss;
winding a subcoil around a third binding boss;
winding the subcoil by sequentially passing the eighth stator core, the second stator core, and the fifth stator core and then cutting the subcoil; and
winding the subcoil drawn out of the fifth stator core around the fourth binding boss so as to be connected to the main coil.

20. The method of claim 19, wherein the winding of the main coil and the winding of the subcoil further comprise winding the main coil and the subcoil around respective coil support parts.
